(19) United States
(12) Patent Application Publication
(10) Pub. No.: US 2022/0019873 A1
(43) Pub. Date: Jan. 20, 2022

(54) ELASTIC BOTTLENECK ARCHITECTURES FOR VARIABLE CONVOLUTION OPERATIONS

(71) Applicant: QUALCOMM Incorporated, San Diego, CA (US)

(72) Inventors: Jamie Menjay LIN, San Diego, CA (US); Fatih Murat PORIKLI, San Diego, CA (US)

(21) Appl. No.: 17/379,833

(22) Filed: Jul. 19, 2021

Related U.S. Application Data
(60) Provisional application No. 63/054,147, filed on Jul. 20, 2020.

(51) Int. Cl. G06N 3/04; G06N 3/08

(52) U.S. Cl. CPC G06N 3/04; G06N 3/08

(57) ABSTRACT

In one aspect of the present disclosure, a method includes: determining a number of loops for a convolution layer of an elastic bottleneck block; for each loop of the number of loops: loading a loop-specific set of convolution weights; performing a convolution operation using the loop-specific set of convolution-weights; and storing loop-specific convolution results in a local memory; and determining an output of the convolution layer based on a summation of loop-specific convolution results associated with each loop of the number of loops.

### CROSS-REFERENCE TO RELATED CASES

This application claims the benefit of and priority to U.S. Provisional Patent Application No. 63/054,147, filed on Jul. 20, 2020, the entire contents of which are incorporated herein by reference.

### INTRODUCTION

Aspects of the present disclosure relate to machine learning.

Machine learning may produce a trained model (e.g., an artificial neural network, a tree, or other structures), which represents a generalized fit to a set of training data that is known a priori. Applying the trained model to new data produces inferences, which may be used to gain insights into the new data. In some cases, applying the model to the new data is described as “running an inference” on the new data.

Machine learning models are seeing increased adoption across myriad domains, including for use in classification, detection, and recognition tasks. For example, machine learning models are being used to perform complex tasks on electronic devices based on sensor data provided by one or more sensors onboard such devices, such as automatically classifying features (e.g., faces) within images.

Machine learning capabilities are often enhanced by dedicated hardware for performing machine learning tasks, including training and inferencing. For example, dedicated inferencing processors may be optimized for performing rapid inferencing based on model input data. But as with all hardware that goes into processing devices—especially size and power-limited devices, such as mobile devices, always-on device, edge processing devices, and the like—there are design constraints and compromises necessary to meet overall product specifications.

For example, a dedicated inferencing processor, particularly in the form of an integrated circuit (IC) or application specific integrated circuit (ASIC) chip, may be constrained by physical resource capacities, such as the buffer/memory size, the size of a data path, the capability of a vector and/or matrix multiplication unit, etc. Consequently, the size of model that the dedicated inferencing processor can implement is likewise limited. As one example, a deep learning model may be limited in the number of channels supported in a convolution layer based on physical constraints of the processing hardware.

This problem is compounded by the trend of machine learning models becoming larger as they become more capable. Thus, fielded processing hardware may rapidly become unable to implement the latest models, greatly diminishing the utility of existing processing hardware.

A similar problem arises when dedicated machine learning hardware (e.g., an inferencing processor) is oversized for a particular model, or a particular context or use case of a model, and thus processing cycles, power, and the like may be wasted when a smaller model is processed by oversized hardware. Generally, the fixed nature of model size and hardware configuration leads to frequent inefficient pairing between machine learning model architecture and machine learning processing hardware.

Accordingly, what is needed are systems and methods for improving the capability of existing processing hardware to deal with a dynamic range of machine learning models sizes without changing the physical capabilities of the hardware.

### BRIEF SUMMARY

Certain aspects provide a method, including: determining a number of loops for a convolution layer of an elastic bottleneck block; for each loop of the number of loops: loading a loop-specific set of convolution weights; performing a convolution operation using the loop-specific set of convolution-weights; and storing loop-specific convolution results in a local memory; and determining an output of the convolution layer based on a summation of loop-specific convolution results associated with each loop of the number of loops.

Further aspects provide a method, including: training a first set of weights for an elastic bottleneck block to operate in a basic mode, wherein: in the basic mode, each convolution layer of the elastic bottleneck block is configured to loop once; training a second set of weights for the elastic bottleneck block to operate in an extended mode, wherein: in the extended mode, one or more convolution layers of the elastic bottleneck block are configured to loop more than once; and storing the first set of weights and the second set of weights in a memory accessible to the elastic bottleneck block.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example of an elastic bottleneck block.

FIG. 2A depicts example flows for basic and extended convolution modes using a three-layer bottleneck block.

FIG. 2B depicts an example of extended pointwise convolution processing.

FIG. 3 depicts a comparison of a basic convolution mode processing flow and an extended convolution mode processing flow.

FIG. 4 depicts an example method for inferencing using an elastic bottleneck block.

FIG. 5 depicts an example method for training an elastic bottleneck block.

FIG. 6 depicts an example processing system for performing the various aspects described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide a scalable machine learning model architecture, which enables variable machine learning model expressiveness without changing the underlying physical resources (e.g., memory size, number of convolution channels, bit width, etc.) available to the processing hardware allocated to processing a machine learning model. In particular, the scalable machine learning model architectures described herein implement elastic bottleneck blocks that may be configured to expand or contract a model based on contexts, use cases, and conditions so that hardware use is optimized and hardware design is less constrained compared to fixed-size machine learning model architectures. Beneficially, the elastic bottle neck blocks may be configured dynamically (e.g., at runtime) as well as statically (e.g., during model design).

Bottleneck blocks are convolution structures used in many machine learning model architectures to improve efficiency. Conventional bottleneck blocks may be used to reduce the number of channels during convolution operations (thus acting as an information “bottleneck”) using efficient pointwise convolutions (e.g., convolutions having a 1×1 sized kernel). For example, an initial pointwise convolution layer in a bottleneck block may reduce the number of channels for a subsequent depthwise convolution layer (e.g., using a 3×3 convolution kernel). Reducing the number of channels for intermediate layers in a bottleneck block reduces the number of parameters required for the intermediate layers and thereby reduces computational cost (for processing the parameters) and memory use (for storage of the parameters), generally with minimal loss in performance. Generally, a final pointwise convolution of a bottleneck block may be used to set the number of output channels in the block output, which may be the same or different than the input to the bottleneck block depending on configuration. Conventionally, bottleneck blocks have a fixed number of parameters and thus a fixed expressiveness. Such conventional bottleneck blocks may be referred to as “inelastic bottleneck blocks.”

Aspects described herein relate to “elastic” bottleneck block architectures that enable dynamic scaling of computations in bottleneck blocks of a machine learning model to enable dynamic expressiveness of the machine learning model. Beneficially, elastic bottleneck blocks may be substituted for existing bottleneck blocks of popular convolutional neural network (CNN) architectures, such as MobileNetV2, MobileNetV3, EfficientNet, and others, without further modification to those network architectures, thereby enhancing the capabilities of those networks. Further, elastic bottleneck blocks may be implemented in other and new model architectures to improve performance compared to conventional approaches.

As described in more detail below, the flexible nature of an elastic bottleneck block architecture may be achieved by selectively expanding or contracting processing within the elastic bottleneck block while. Further, an elastic bottleneck block may be configured to constrain the input and output sizes (e.g., number of channels) in order to replace an existing bottleneck block in an existing model architecture.

In various aspects, expanding or contracting the processing within an elastic bottleneck block is made possible by serially processing additional data in a configured number of “loops” through various model layers in the bottleneck block. Generally, adding loops to the processing allows for processing additional data with additional weights in each additional loop. The number of loops may be increased or decreased based on context, use case, or other conditions at runtime to enable flexibility and efficiency without the need to change underlying hardware. In some cases, the number of loops may be based on a number of channels of data selected for processing.

Further, in some aspects, channels of input data may be analyzed (e.g., during training) and ranked and/or sorted by importance or effect on the ultimate model output and a subset of the total set of channels of input data available may be chosen at runtime for processing. Configurable looping enables an efficient mechanism for expanding and contracting the number of channels for processing by an elastic bottleneck block.

There are many use cases for the elastic bottleneck block architectures described herein. Generally, any use case or context in which a machine learning model's processing requirements are multi-modal or conditional can benefit from elastic bottleneck block architectures.

For example, in a multi-sensor system, such as a fully or semi-autonomous vehicle, not all sensors are needed or available all the time. By way of example, when driving in clear weather, the vehicle may use camera data and LiDAR data to assist navigation. However, in inclement weather, the vehicle may use additional data, such as radar data. The additional sensor data, which is used based on conditions, may exceed the design constraints of existing machine learning model processing hardware, or require more powerful hardware so that all possible input data needs to be processed all the time, which is inefficient. By contrast, the use of elastic bottleneck block architectures allows for the ability to selectively use the additional data by dynamically expanding or contracting operations in the bottleneck block to account for the additional or unnecessary data, as needed based on conditions (e.g., clear or inclement weather). Thus, the capabilities of the existing processing hardware is extended without underlying hardware changes, and the efficiency and capability of the processing system hardware is greatly improved.

The improved efficiency of the processing system in the aforementioned example and in others may lead to reduced power use, reduce heat generation, reduced memory use, longer battery life, improved availability of processing cycles for other systems in a shared processing environment, additional device availability, and wider model deployment possibilities, to name a few benefits. Further, the improved efficiency of the processing system may allow for processing of a wider variety of, and newer, machine learning model architectures as machine learning continues to evolve. Thus, existing processing hardware may have its performance improved and its useful life extended, and new hardware may be designed with fewer constraints based on then-available model architectures.

### Example of Elastic Bottleneck Block

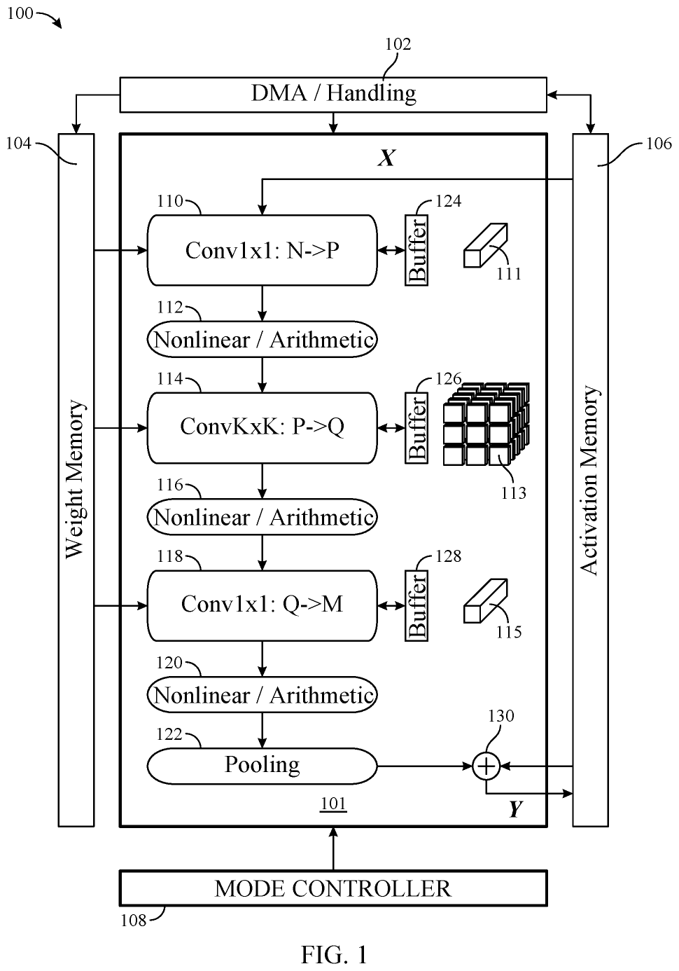

FIG. 1 depicts an example of an elastic bottleneck block architecture 100 including an elastic bottleneck block 101.

In this example, elastic bottleneck block 101 includes a first pointwise convolution layer 110 configured to process input data (X) using a pointwise convolution kernel 111. In some cases, the pointwise convolution layer 110 may be used to reduce the dimensionality of the data for the depthwise convolution layer 114 in order to improve the efficiency of the depthwise convolution. The output of pointwise convolution layer 110 is input for a nonlinear or arithmetic operation block 112, which may in some examples be a nonlinear activation block, such as a ReLU block. The output of block 112 is input for a K×K depthwise convolution layer 114 configured to process data using a depthwise convolution kernel 113, where K>1. The output of convolution layer 114 is input for another nonlinear or arithmetic block 116, which may likewise be a nonlinear activation block. The output of block 116 is input for a second pointwise convolution layer 118 configured to process input data using pointwise convolution kernel 115. The output of pointwise convolution layer 118 is input for another nonlinear or arithmetic operation block 120, which may be a nonlinear activation block. The output of block 120 is input for pooling layer 122 (e.g., max pooling, average pooling, etc.). Finally, the output of pooling layer 122 is provided to accumulator 130. Accumulator 130 may act as a summation operator (e.g., a pointwise summation operator) to add intermediate convolution output data to other intermediate convolution output data stored in activation memory 106. Notably, this is just one example of an elastic bottleneck block, and others with different layer arrangements and structures are possible.

In the example of FIG. 1, each of the convolution layers 110, 114, and 118 is associated with a local buffer, 124, 126, and 128, respectively. These buffers are generally usable as a “scratch space” reserved for their respective layer to hold all local computations or accumulations. As explained in more detail below, local buffers 124, 126, and 128 can be used to store data, such as input data and weights, when looping through a layer multiple times. These buffers may receive data, for example, from weight memory 104 and activation memory 106.

Elastic bottleneck block 101 is in data communication with a weight memory 104 for providing weights for convolution layers 110, 114, and 118 (e.g., by way of a host system memory and DMA 102), as well as an activation memory 106 for storing the output of elastic bottleneck block 101.

Elastic bottleneck block 101 is also in data communication with a mode controller 108, which includes control and handling logic for the execution of elastic bottleneck block 101. For example, the control logic may specify and control the convolution operations in layers 110, 114, and 118 based on parameters, such as loop parameters (as described in more detail below), for each layer. As described further below, mode controller 108 may configure elastic bottleneck block 101 in a “basic” mode for conventional operations, or in one or more extended modes that implement looping and/or channel selection for variable expressivity of the model.

The convolution operations for a single bottleneck block, such as elastic bottleneck block 101, may be generally described as follows, where certain operations (e.g., batch norm, nonlinearity, etc.) are omitted from the mathematical description for simplicity, though those non-convolution operations are included in actual execution.

A pointwise convolution, such as performed in pointwise convolution layers 110 and 118, may be mathematically modeled as Y=WX, where X∈ [symbol] ^{C}^{ᵢₙ} is the input vector of size Cᵢₙ, W∈ [symbol] ^{C}^{ₒᵤₜ}^{×C}^{ᵢₙ} denotes the weight matrix, Y∈ [symbol] ^{C}^{ₒᵤₜ} denotes the output vector of size Cₒᵤₜ, and C generally denotes the number of channels in (Cᵢₙ) or out (Cₒᵤₜ) of a layer.

The mathematical formulation for a pointwise convolution may be extended to depthwise convolutions with K×K kernels (alternatively referred to as filters), where K>1, such as in layer 114, by using kernel entry indexing. For example, for K=3, all 9 weight entries for a channel may be indexed from 0 to K²−1=8 (using 0-based indexing in this example, but other indexing is equally suitable) and represented in a vector format. Kernel entry indexing thus allows a mathematical model for a depthwise convolution to nevertheless retain the form of Y=WX.

### Layer Looping in Elastic Bottleneck Blocks

Still referring to FIG. 1, the flexible nature of the elastic bottleneck block 101 is achieved in some aspects by selectively expanding or contracting processing within block 101, and constraining the input (X) and output (Y) sizes of the data processed by elastic bottleneck block 101 where elastic bottleneck block 101 is meant to replace an existing bottleneck block with set input and output sizes.

In order to expand the processing capabilities of elastic bottleneck block 101, layer looping may be implemented. Layer looping is generally the concept of processing more than one set of input and weight data in a given layer by looping back through the layer some number of times. This looping allows for extending the amount of data processed by a layer without changing the size of the layer. Layer looping may be applied to some or all of the convolution layers in an elastic bottleneck block, such as 101.

In order for layer looping to increase expressivity, different weights may be applied in each processing loop of the layer. For example, each loop may be indexed, and a loop-specific set of weights W_{layer}^{index} may be loaded based on loop index. By way of example, W₁⁰ and W₁¹ correspond to weights to be used for loop index “0” and “1” of layer “1” for a zero-based indexing scheme (in other examples, the indexing may be one-based instead). Thus, layer looping allows processing of the same input data X using more than one set of weights for each layer (e.g., different weights per loop of a given layer). Because the intermediate outputs of each loop may be stored and accumulated, the underlying hardware (e.g., buffer sizes, etc.) need not be changed to accommodate the additional processing capability. It follows, then that variable expressivity can be achieved by changing the looping characteristics of various layers of an elastic bottleneck block (e.g., 101).

Looping of layers within an elastic bottleneck block, such as 101, may be configured per layer. In some aspects, looping may be configured by setting a loop parameter for a given convolution layer, which corresponds to the number of times the given convolution will be “looped” back through. For example, a pointwise convolution layer (e.g., 110) may be looped for n times and then the output of the final execution of the nth loop of pointwise convolution layer 110 may then processed by nonlinear or arithmetic operation block 112, which then becomes input for convolution layer 114. In some aspects, the loop parameter may be interpreted and implemented by mode controller 108. In some aspects, the loop parameter may be stored in a local layer buffer (e.g., 124, 126, or 128) during processing of elastic bottleneck block 101.

As above, layer looping may be controlled, for example, by mode controller 108 in FIG. 1. For example, mode controller 108 may configure how many loops are to be performed by each layer (e.g., 110, 114, and 118 of FIG. 1), may control the bypassing of various layers during looping, indexing of input, etc.

### Extended Convolution Modes Using Looped Layer Outputs

As above, layer looping allows for creating additional intermediate activations, which can be used for an extended convolution operation, beneficially, without extending the underlying hardware capabilities.

When performing an extended convolution operation using an elastic bottleneck block (e.g., 101 in FIG. 1), the input size (e.g., in terms of channels in this example) for a first convolution layer, C_{1,in} may be kept the same as in a basic convolution mode. However, the number of output channels (C_{1,out}) may be extended to C*_{1,out} (e.g., the channel count may be increased) as compared to the basic convolution mode to enable an extended convolution. Beneficially, the extended output size (C*ₒᵤₜ) allows for injecting new input data into the intermediate processing of an elastic bottleneck block without changing the input size of X because C*_{1,out}>C_{1,out}.

For a second convolution layer, there are two possible intermediate layer modes. In a first intermediate layer mode, the number of input channels to the layer (C_{2,in}) is set equal to C*_{1,out} (i.e., C_{2,in}=C*_{1,out}) and the number of output channels from the layer (C_{2,out}) remains unchanged from the basic convolution mode. Thus, in this first intermediate layer mode, the extension of the convolution is confined to the intermediate operations between the first and second convolution layers. This may be referred to as a layer channel output static mode.

Alternatively, in a second intermediate layer mode, the number of input channels to the layer (C_{2,in}) is set equal to the number of channels output from the previous layer (C_{1,out}) and the number of output channels (C_{2,out}) is extended to C*_{2,out} from the basic convolution mode, where C*_{2,out}>C_{2,out}. The second intermediate layer mode may be referred to generally as a layer channel output extending mode. Extending the number of output channels may generally increase the expressivity of the model because more data can be processed.

For example, where additional data is available, that data may be processed by extending the number of channels, or where data become unavailable, the number of channels may be contracted. As another example, where the operating conditions of a processing device have changed, such as a device goes from a battery-powered to a mains-powered condition, the number of channels may be extended since power efficiency may be traded for model performance in such a condition, and vice versa. As yet another example, if a processing system goes from an overheated to a normal operating temperature, the number of channels may be extended, or vice versa. Notably, these are just a few examples, and many others are possible.

Then, for a third convolution layer, the number of input channels to the layer (C_{3,in}) may be set equal to the number of output channels of the previous layer (C*_{2,out}). If, as in elastic bottleneck block 101, the third convolution layer is the last layer of the bottleneck block, then C_{3,out} may be left the same as in a basic mode, and thus the output size is unchanged for the bottleneck block even though the intermediate sizes were changed. If, on the other hand, the third convolution layer is not the last convolution layer of the bottleneck block, then the same choice of intermediate layer modes may be selected, as above.

When either C_{layer,in} or C_{layer,out} is increased from the basic convolution mode for a layer, multiple corresponding weight submatrices (e.g., W₁⁰ and W₁¹) are loaded from a memory of buffer storing weights, such as weight memory 104 of FIG. 1 and these weight submatrices are processed individually in loops. Notably, accumulators, such as 130 in FIG. 1, may be sufficiently sized to hold the extended data from an extended convolution mode.

The following mathematical expressions compare a basic convolution mode with an extended convolution mode using the example architecture of elastic bottleneck block 101. Note that this is just one example, and many others are possible based on other bottleneck block architectures.

An example mathematical model of a basic convolution mode, using the example architecture of FIG. 1, is as follows:

Y₀⁰=σ(W₁⁰X)

Y₂⁰=σ(W₂⁰Y₁⁰)

Y=σ(W₃⁰Y₂⁰)

[symbol]

Y=σ(W₃⁰σ(W₂⁰σ(W₁⁰X)))

Superscripts in the above notations represent a loop index and subscripts represent a layer index, e.g., W_{layer}^{index} and Y_{layer}^{index}. Notably, because the example above relates to a basic mode of convolution where there is no looping, the loop index is the same (0) for all operations. Further, in the expressions above, σ(⋅) is generally used to denote a nonlinearity operation, such as a nonlinear activation function like ReLU. However, in a case where nonlinearity is not needed or applied, the corresponding σ(⋅) may instead be defined as an identify function, such as Y=ƒ(X)=X so that the same mathematical description may otherwise be maintained. The preceding expressions may assume the use of the full physical capacity of a machine learning model processor processing each expression.

Thus, in the basic mode of convolution, each convolution layer may be configured to run exactly 1 loop for a layer. In other words, elastic bottleneck block 101 may be configured to act as a conventional bottleneck block when each layer is set to loop only once, and can be configured to enhance the expressivity of block by enabling more than a single loop for one or more of the convolution layers, where each loop may have an associated set of weights specific to that loop (e.g., as associated by a loop index number).

By contrast, an example mathematical model of an extended convolution mode, using the example architecture of FIG. 1, is as follows where * symbols represent extended data for processing compared to the basis convolution mode:

$$[ \begin{matrix}{Y}_{1}^{0} \\ {Y}_{1}^{1 *}\end{matrix} ] = σ ( [ \begin{matrix}{W}_{1}^{0} \\ {W}_{1}^{1 *}\end{matrix} ] X ) \\ [ \begin{matrix}{Y}_{2}^{0} \\ {Y}_{2}^{1 *}\end{matrix} ] = σ ( [ \begin{matrix}{W}_{2}^{0} & {W}_{2}^{1 *} \\ {W}_{2}^{2 *} & {W}_{2}^{3 *}\end{matrix} ] [ \begin{matrix}{Y}_{1}^{0} \\ {Y}_{1}^{1 *}\end{matrix} ] )$$

$$Y = σ ( [ {W}_{3}^{0} {W}_{3}^{1 *} ] [ \begin{matrix}{Y}_{2}^{0} \\ {Y}_{2}^{1 *}\end{matrix} ] )$$

$$Y = σ ( {W}_{3}^{0} {Y}_{2}^{0} + {W}_{3}^{1 *} {Y}_{2}^{1 *} ) = σ ( {W}_{3}^{0} σ ( {W}_{2}^{0} {Y}_{1}^{0} + {W}_{2}^{1 *} {Y}_{1}^{1 *} ) + {W}_{3}^{1 *} σ ( {W}_{2}^{2 *} {Y}_{1}^{0} + {W}_{2}^{3 *} {Y}_{1}^{1 *} ) ) = σ ( {W}_{3}^{0} σ ( {W}_{2}^{0} σ ( {W}_{1}^{0} X ) + {W}_{2}^{1 *} σ ( {W}_{1}^{1 *} X ) ) + {W}_{3}^{1 *} σ ( {W}_{2}^{2 *} σ ( {W}_{1}^{0} X ) + {W}_{2}^{3 *} σ ( {W}_{1}^{1 *} X ) ) )$$

Notably, the preceding expressions for the extended convolution mode allow for a more complex (and thus more expressive) model using the same physical capacity of the machine learning model processor. This is demonstrated by the fact that whereas W₀¹, W₂⁰, and W₃⁰ are the weight matrices of maximum dimensionality supported in the basic mode, the extended mode allows for processing additional weight matrices associated with additional feature data, including: W₂¹*, W₂²*, W₂³*, and W₃¹*.

Further, weight matrices used for extended convolution modes (such as W₁¹*, W₂¹*, and W₃¹*, above) may themselves comprise one or more sub-matrices so that the model capacity (or expressiveness) can be further expanded for the corresponding layer.

For example, an expanded weight matrix may be defined as follows:

$${W}_{1}^{1} = [ \begin{matrix}{W}_{1}^{1 , 0} \\ {W}_{1}^{1 , 1} \\ … \\ {W}_{1}^{1 , P - 1}\end{matrix} ] ,$$

such that

$$[ \begin{matrix}{Y}_{1}^{0} \\ {Y}_{1}^{1}\end{matrix} ] = [ \begin{matrix}{W}_{1}^{0} \\ {W}_{1}^{1}\end{matrix} ] X = [ \begin{matrix}{W}_{1}^{0} \\ [ \begin{matrix}{W}_{1}^{1 , 0} \\ {W}_{1}^{1 , 1} \\ … \\ {W}_{1}^{1 , P - 1}\end{matrix} ]\end{matrix} ] X$$

In another example, an expanded weight matrix may be defined as follows:

$${W}_{2}^{1} = [ {W}_{2}^{1 , 0} {W}_{2}^{1 , 1} … {W}_{2}^{1 , Q - 1} ] and$$

$${W}_{2}^{3} = [ {W}_{2}^{3 , 0} {W}_{2}^{3 , 1} … {W}_{2}^{3 , Q - 1} ] , such that \\ [ \begin{matrix}{Y}_{2}^{0} \\ {Y}_{2}^{1}\end{matrix} ] = [ \begin{matrix}{W}_{2}^{0} & {W}_{2}^{1} \\ {W}_{2}^{2} & {W}_{2}^{3}\end{matrix} ] [ \begin{matrix}{Y}_{1}^{0} \\ {Y}_{1}^{1}\end{matrix} ] = [ \begin{matrix}{W}_{2}^{0} & [ {W}_{2}^{1 , 0} & {W}_{2}^{1 , 1} & … & {W}_{2}^{1 , Q - 1} ] \\ {W}_{2}^{2} & [ {W}_{2}^{3 , 0} & {W}_{2}^{3 , 1} & … & {W}_{2}^{3 , Q - 1} ]\end{matrix} ] [ \begin{matrix}{Y}_{1}^{0} \\ {Y}_{1}^{1}\end{matrix} ] ,$$

where P>1 and Q>1 are integers in the preceding expression.

In other words, the additional weights (e.g., in the form of weight matrices) for extended convolutions layers are not limited to only one set (e.g., one matrix), but may be comprised of one or more subsets (e.g., one or more matrices or sub-matrices).

In some cases, the weights for extended convolutions modes may be selected based on the significance of the weight to the model output. For example, the significance might be based on the absolute value of the weight in some cases.

Extended convolution mode may be controlled, for example, by mode controller 108 in FIG. 1. For example, mode controller 108 may configure the extended layer input and/or output sizes, the intermediate layer modes for each intermediate layer, etc.

### Extended Convolution Capabilities of Elastic Bottleneck Blocks

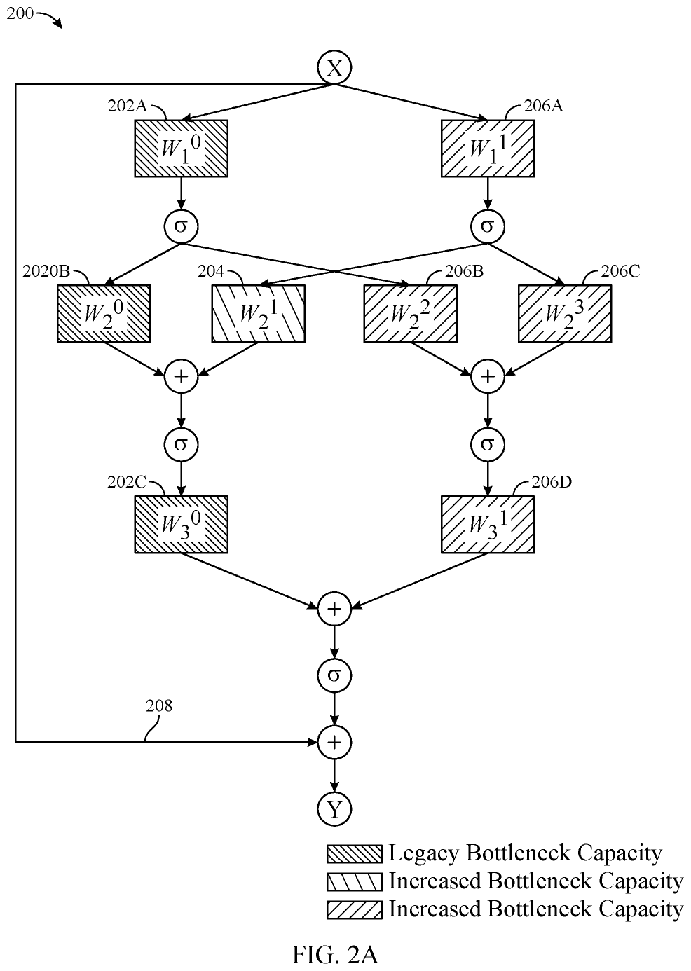

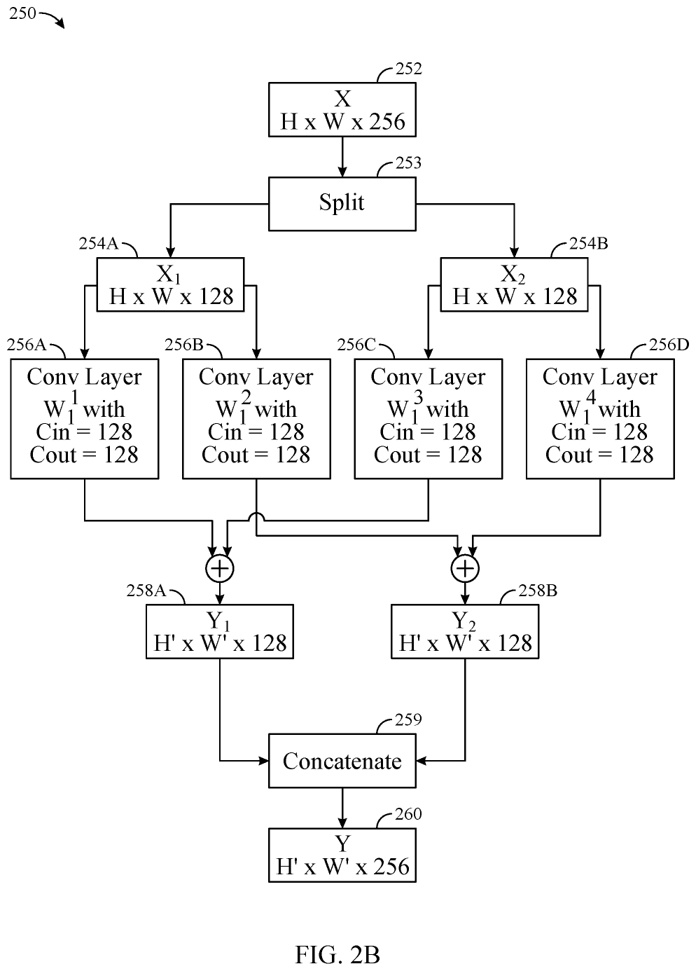

FIG. 2A depicts example flows for basic and extended convolution modes using a three-layer bottleneck block 200, such as the example bottleneck block 101 of FIG. 1. In the example of FIG. 2A, a skip (or “identity”) connection 208 is included from the input to the final output summation.

In the depicted example, blocks 202A-C (depicted with a first cross-hatching pattern), represent a processing path for a basic convolution mode without extension of any intermediate layer.

Block 204 (depicted with a second cross-hatching pattern) represents an extension of a single layer input, such as described above with respect to the first intermediate layer mode. Accordingly, in a first example of an extended convolution, blocks 202A-C and 204 are processed to generate the output Y without changing the input data size of X or the output size of Y. This represents an increase in the bottleneck capacity provided by blocks 202A-C.

Blocks 206A-D (depicted with a third cross-hatching pattern) represents an extension of more than one layer input and/or output, such as described above with respect to the second intermediate layer mode. Accordingly, in a second example of an extended convolution, blocks 202A-C, 204, and 206A-D are all processed to generate the output Y, again without changing the input data size of X or the output size of Y. This represents another increase in the bottleneck capacity provided by blocks 202A-C.

Thus, FIG. 2A depicts the “elastic” nature of the convolution modes within elastic bottleneck blocks, which can be configured in a basic mode, or in multiple extended modes depending on bottleneck block architecture, looping configuration, and intermediate layer modes, all resulting in variable expressivity. It is apparent that the elastic bottleneck architecture with looping and layer extension enables increased model expressiveness with more weights, more sophisticated convolutions, and more nonlinearity (e.g., by more nonlinear operations σ) based on a depth-first data and execution pipeline. Because a nonlinear operation in an artificial neural network is analogous to branching logic in a computer program. Thus, more nonlinearity implies greater expressiveness of the artificial neural network model.

The elastic bottleneck architecture thus enables conditional multi-modal/multi-source processing for deep neural network models. For example, consider a design that is already using its full physical resources on an inference engine. If there was a conditional or occasional need to handle a larger number of features, such as from additional types of sensor sources (multi-modal sensing) or additional instances of sensor sources (multi-source sensing), the elastic bottleneck architecture may be used to accommodate the additional features through intermediate layer extension, as described above. And those additional features may be beneficially trained using feature-specific weight sets.

For example, as in FIG. 2A, W₂¹ may be selectively used in a first extended convolution mode when a new input data feature is available. Further, W₁¹, W₂², W₂³, and W₃¹ may be selectively used in a second extended convolution mode when further input data features are available. In this example, there are at least three different levels of expressivity of the bottleneck block based on what input data is available, and these may be selected based on conditions. Thus, the bottleneck block may be expanded to leverage the addition data, when desired, or contract when the data is either unavailable or unneeded. As above, this is accomplished without needing to add or expand the physical resources of a machine learning model processor, such as a model inference engine.

FIG. 2B depicts an example 250 of extended pointwise convolution processing.

In the depicted example, the input data 252 (X) has a dimensionality of H× W×256 (C_{1,in}=256), which may represent the total amount of data channels available for processing at an elastic bottleneck block. In this example, all of the data channels are selected for processing, e.g., by mode controller 108 in FIG. 1, but the underlying processing hardware may be limited to or optimized for 128 channels, which may be the standard input size for the elastic bottleneck block in the basic operating mode. In order to process the additional data in this example, input data 252 is split at block 253 into input data subsets X₁ and X₂, which each have dimensionality of H×W×128.

Convolution processing is then performed on input data subsets X1 and X2 at blocks 256A-256D with four distinct sets of weights, W₁¹, W₁³, and W₁⁴. The results of convolution processing blocks 256A-256D are then accumulated (256A with 256C, and 256B and 256D) to generate intermediate outputs 258A (Y₁) and 258B (Y₂).

Finally, the intermediate results are concatenated to return the output 260 (Y) channel dimensionality (C_{1,out}) to 256 channels. Note, in other examples the output dimensionality might be reduced, such as when the processing in example 250 is a first pointwise convolution layer in an elastic bottleneck block. For example, a pooling layer such as 122 in FIG. 1 may be used to downsample the output.

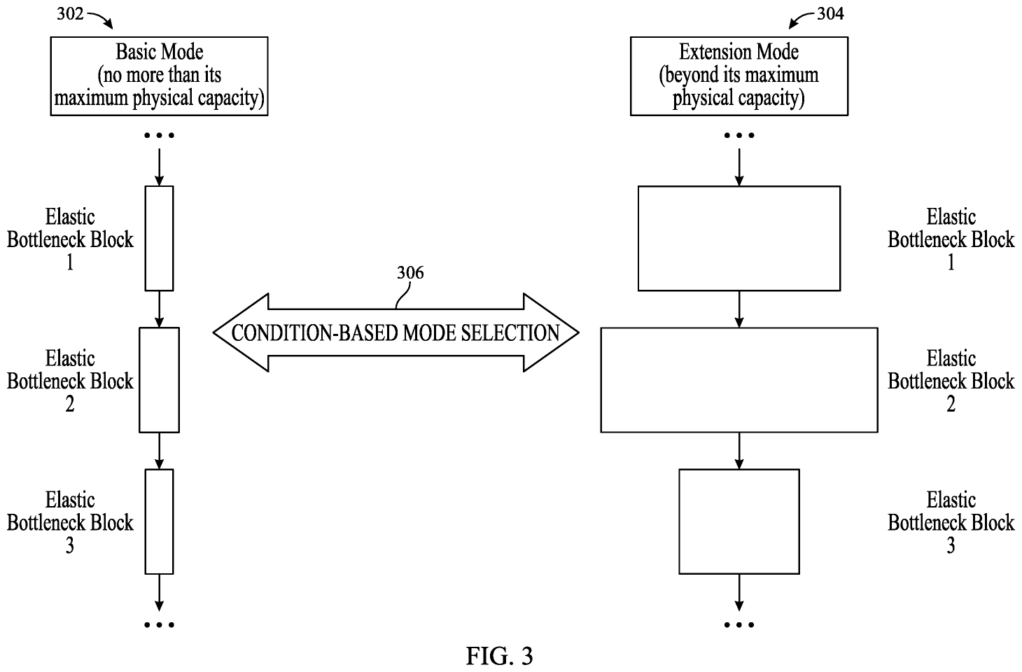

FIG. 3 depicts another comparison of a basic convolution mode processing flow 302 and an extended convolution mode processing flow 304, where the widths of the elastic bottleneck blocks are used to indicate relative expressiveness of each bottleneck block (wider being more expressive). Further, each flow, 302 and 304, includes multiple elastic bottleneck blocks to demonstrate that the benefit of an elastic bottleneck block may be accumulated multiple times when processing an overall model architecture. Further, because different bottleneck block may include different numbers of layers and channels, the elastic bottleneck blocks in each flow are indicated as different widths.

As depicted, in the basic convolution mode 302, the expressivity may generally be limited as in a conventional bottleneck block architecture, which itself may be designed around a hardware limitation of a device on which the model is being deployed. By contrast, in the extended convolution mode 304, one or more layers of the elastic bottleneck blocks may be extended, as described above, to consider additional data, which increases expressivity.

Similarly, a processing system may start in a maximally extended convolution mode (e.g., as in example flow 304) and move back towards a basic mode (e.g., as in example flow 302) based on context, use case, and/or conditions. That is, it is not necessary that an elastic bottleneck block always starts in a basic mode and then expand; rather, the elastic bottleneck block may start in an extended state and step down (e.g., less expressive) or up states (e.g., more expressive) based on context, use case, and/or conditions, such as indicated by condition-based mode selection arrow 306. As above, the expansion or contraction of the model may be accomplished based on a number of loops and amount of input data (e.g., number of channels) configured for each bottleneck block. Thus, while FIG. 3 depicts two example modes via processing flows 302 and 304, these may be considered ends of a spectrum in which any number of intermediate modes may be defined based on context, use case, conditions, etc.

### Example Inferencing Method Using an Elastic Bottleneck Block and Extended Convolution

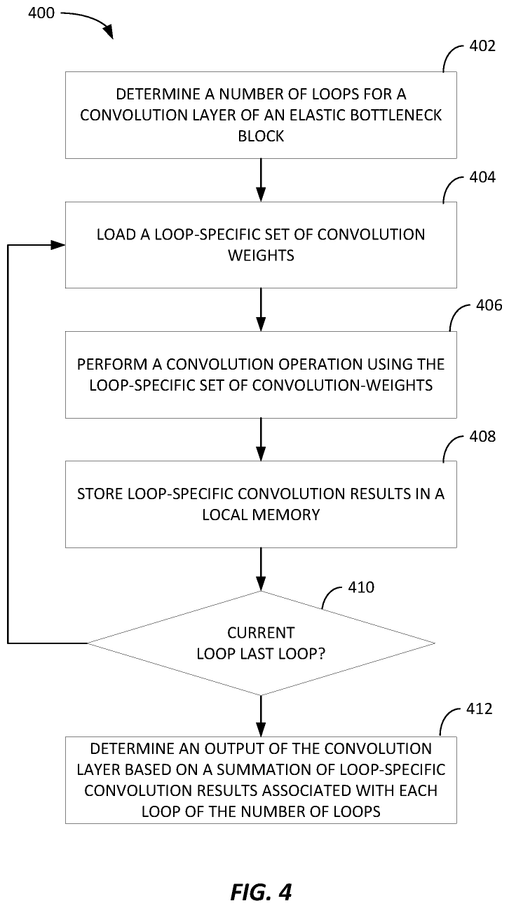

FIG. 4 depicts an example method 400 for inferencing using an elastic bottleneck block, such as that depicted and described above with respect to FIGS. 1 and 2.

Method 400 begins at step 402 with determining a number of loops for a convolution layer of an elastic bottleneck block. As described above, the number of loops does not change an input size or an output size of the elastic bottleneck block. In some aspects, the number of loops may be based on a looping parameter that is configured by a mode controller, such as 108 in FIG. 1.

Method 400 then proceeds to step 404 with loading a loop-specific set of convolution weights. For example, weights for a 2nd loop of a 2nd layer of the elastic bottleneck block, W₂², may be loaded. In some aspects, the loop-specific set of convolution weights may be loaded from a weight memory or buffer, such as weight memory 104 in FIG. 1. In some aspects, the weights may be store in a layer-specific buffer, such as buffer 124, 126, or 128 in FIG. 1.

Method 400 then proceeds to step 406 with performing a convolution operation using the loop-specific set of convolution-weights.

Method 400 then proceeds to step 408 with storing loop-specific convolution results in a local memory. In some aspects, the local memory may be a buffer, such as buffer 124, 126, or 128 of FIG. 1.

Method 400 then proceeds to step 410 with determining if a current loop is the last loop based on the number of loops. If the current loop is not the last loop, then the process may return to step 404; otherwise, if it is the last loop, the process may proceed to step 412.

For example, if the current loop number is lower than the number of loops configured for the convolution layer, then method 400 returns to step 404 to commence another loop of the convolution layer. If the current loop number is equal to the number of loops configured for the convolution layer, then method 400 proceeds to step 412.

At step 412, method 400 proceeds with determining an output of the convolution layer based on a summation of loop-specific convolution results associated with each loop of the number of loops. For example, intermediate results stored in a local buffer, such as buffer 124, 126, or 128 in FIG. 1, may be accumulated and then provided as input to a following layer.

In some aspects, method 400 further comprises accumulating the loop-specific convolution results to a current convolution results value stored in the local memory.

In some aspects, method 400 further comprises: determining an intermediate layer mode for the convolution layer of the elastic bottleneck block; and configuring a loop parameter based on the intermediate layer mode, wherein the loop parameter configures the number of loops. For example, the layer mode may be a layer channel output static mode or a layer channel output extending mode, as described above.

In some aspects, method 400 further comprises: performing a nonlinear operation on the output of the convolution layer to generate intermediate activation data; and providing the intermediate activation data as an input to a second convolution layer in the elastic bottleneck block. For example, as depicted in FIG. 1, nonlinear or arithmetic operation block 112 may perform a nonlinear operation, such as ReLU, on the output of convolution layer 110 to generate intermediate activation data for convolution layer 114.

In some aspects, method 400 further comprises: loading bottleneck block configuration data; and configuring a plurality of convolution layers of the elastic bottleneck block based on the configuration data. In some aspects of method 400, the plurality of convolution layers includes the convolution layer, the bottleneck block configuration data configures a loop parameter for each respective layer of the plurality of convolution layers, and the bottleneck block configuration data configures an input size and an output size for each convolution layer of the plurality of convolution layers.

In some aspects, method 400 further comprises: determining the output of the convolution layer based on the summation of loop-specific convolution results associated with each loop of the number of loops and a skip connection from the input of the convolution layer.

In some aspects of method 400, the convolution layer is one of a plurality of convolution layers in the elastic bottleneck block, such as depicted in the example of FIG. 1.

In some aspects of method 400, the convolution layer comprises a pointwise convolution layer, such as pointwise convolution layers 110 and 118 of FIG. 1.

In some aspects of method 400, the convolution layer comprises a depthwise convolution layer, such as depthwise convolution layer 114 in FIG. 1.

In some aspects of method 400, the number of loops is based on a number of input data sources available for the convolution layer. For example, as described above, the number of input data sources may relate to a number of sensor data inputs for a multi-modal process, such as an autonomous driving system.

In some aspects of method 400, the elastic bottleneck block comprises non-convolution layers. For example, the elastic bottleneck block may further comprise a pooling layer, such as pooling layer 122 in FIG. 1.

In some aspects, determining the number of loops for a convolution layer of an elastic bottleneck block, as in step 402, may be based on a selected number of channels to be processed in order to implement a model performance configuration. For example, where context, use case, or conditions call for reduced power use or processing time, a subset of channels from a set of all possible channels of data may be selected for processing. This, in-turn, may be used to determine the number of loops.

In some cases, the number of loops may be based on the number of channels selected for processing as well as a hardware configuration of a processing device. For example, where the processing device is configured for efficient processing of 64 channels of input data, the number of channels selected may be a factor of 64, which then gives an even number of loops. Thus, 1 loop for 64 channels, 2 loops for 128 channels, etc. Note that the number of channels selected need not always be an even factor of a hardware configuration, but it may be desirable to do this for processing efficiency.

In some aspects, the selection of channels may be based on a ranked and/or sorted ordering of the available channels based on expressivity or significance to the model output. Such an ordering may be stored, in one example, with the weights in weight memory 104 of FIG. 1. For example, where more efficient processing is desired, lower-ranked channels may be omitted from a subset selected for processing, and this omission may influence the number of loops determined at step 402. Likewise, where more accurate processing is desired, and a model is not current using all available input data, additional channels may be added to a subset selected for process using, for example, using extended convolution modes as described above. This may likewise influence the number of loops determined at step 402.

Note that while a bottleneck block architecture such as 100 of FIG. 1 has been used throughout this example, method 400 is extendable to other elastic bottleneck block architectures as well.

### Example Training Method for Elastic Bottleneck Block and Extended Convolution

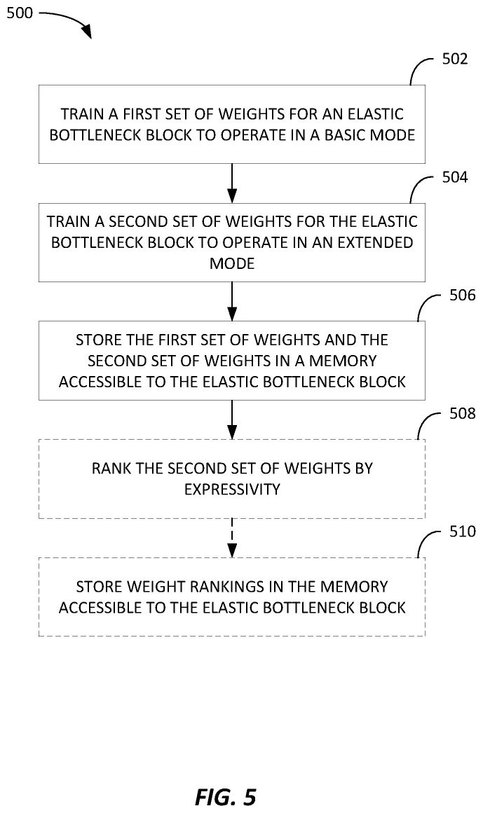

FIG. 5 depicts an example method 500 for training an elastic bottleneck block.

Method 500 begins at step 502 with training a first set of weights for an elastic bottleneck block to operate in a basic mode, wherein: in the basic mode, each convolution layer of the elastic bottleneck block is configured to loop once.

In some aspects, training the first set of weights may include performing inference convolution operations in accordance with the method 400 described with respect to FIG. 4, wherein the loop number for each convolution layer in the elastic bottleneck block is set to 1. The first set of weights may then be updated based on a training algorithm, such as back propagation, and loss function.

Method 500 then proceeds to step 504 with training a second set of weights for the elastic bottleneck block to operate in an extended mode, wherein in the extended mode, one or more convolution layers of the elastic bottleneck block are configured to loop more than once. In some aspects, a mode controller, such as mode controller 108 of FIG. 1, may set the elastic bottleneck block in the extended mode.

In some aspects, training the second set of weights may include performing inference convolution operations in accordance with the method 400 described with respect to FIG. 4, wherein the loop number for at least one convolution layer of the elastic bottleneck block is greater than 1. The second set of weights may then be updated based on a training algorithm, such as back propagation, and loss function.

Method 500 then proceeds to step 506 with storing the first set of weights and the second set of weights in a memory accessible to the elastic bottleneck block. For example, the first and second sets of weights may be stored in a weight memory, such as 104 in FIG. 1.

Method 500 then optionally proceeds to step 508 with ranking the second set of weights by expressivity. In some cases, expressivity may be determined by the influence on the overall model output of each weight. In other cases, expressivity may be determined by an absolute value of the weight. Other methods are possible.

Method 500 then optionally proceeds to step 510 with storing weight rankings in the memory accessible to the elastic bottleneck block, such as weight memory 104 in FIG. 1. In some cases, the weight rankings are stored as an ordered list of weights by weight values. The weight rankings may thereafter be accessed by the elastic bottleneck block when a subset of weights is used based on conditions.

Note that in the example of FIG. 5, two sets of weights are used as an example in training steps 502 and 504. However, any number of sets of weights may be trained and may be associated with different contexts, use cases, or conditions, such as those examples described above. Training multiple sets of weights allows for having multiple steps of model performance, such as multiple steps to expand or contract the elastic bottleneck block in a model, as described above.

### Example Processing Systems

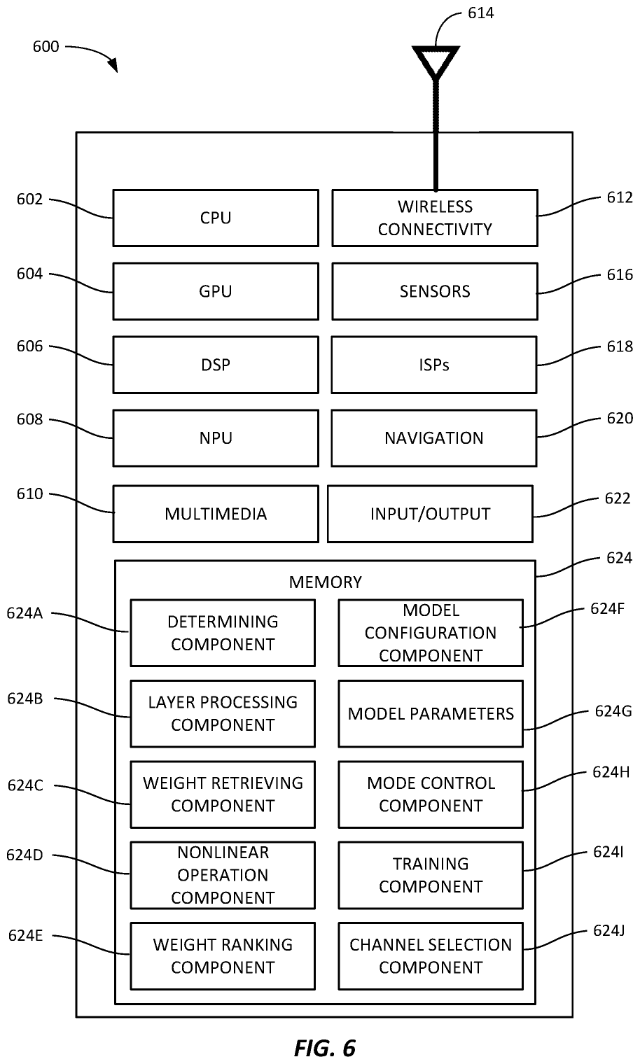

FIG. 6 depicts an example processing system 600 for performing the various aspects described herein, such as the methods described with respect to FIGS. 4 and 5.

Processing system 600 includes a central processing unit (CPU) 602, which in some examples may be a multi-core CPU. Instructions executed at the CPU 602 may be loaded, for example, from a program memory associated with the CPU 602 or may be loaded from a memory 624.

Processing system 600 also includes additional processing components, such as a graphics processing unit (GPU) 604, a digital signal processor (DSP) 606, a neural processing unit (NPU) 608, a multimedia processing unit 610, and a wireless connectivity component 612. Notably, these are just some examples, and others are possible.

An NPU, such as 608, is generally a specialized circuit configured for implementing all the necessary control and arithmetic logic for executing machine learning operations, such as operations for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 608, are configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 608 may be integrated as a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 612 is further connected to one or more antennas 614.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory (DRAM), a flash-based static memory, and the like. In this example, memory 624 includes various computer-executable components, which may be executed by one or more of the aforementioned processors of processing system 600.

In particular, in this example, memory 624 includes determining component 624A, layer processing component 624B, weight retrieving component 624C, nonlinear operation component 624D, weight ranking component 624E, model configuration component 624F, model parameters 624G, mode control component 624H, training component 624I, and channel selection component 624J. The depicted components, and others not depicted, may be configured to perform various aspects of the methods described herein.

Generally, processing system 600 and/or components thereof may be configured to perform the methods described herein. However, in some aspects, such as where a processing system is meant primarily for training (e.g., consistent with FIG. 5), certain of the example components depicted in FIG. 6 may be omitted. For example, an alternative aspect of a processing system configured for training may include various processing units, such as CPU 602, GPU 604, DSP 606, NPU 608, but omit other aspects, such as wireless connectivity 612, sensors 616, ISPs 618, multimedia 610, and navigation 620.

### Example Clauses

Implementation examples are described in the following numbered clauses:

Clause 1: A method, comprising: determining a number of loops for a convolution layer of an elastic bottleneck block; for each loop of the number of loops: loading a loop-specific set of convolution weights; performing a convolution operation using the loop-specific set of convolution weights; and storing loop-specific convolution results in a local memory; and determining an output of the convolution layer based on a summation of loop-specific convolution results associated with each loop of the number of loops.

Clause 2: The method of Clause 1, further comprising, for each loop of the number of loops, accumulating the loop-specific convolution results to a current convolution results value stored in the local memory.

Clause 3: The method of any one of Clauses 1-2, further comprising: determining an intermediate layer mode for the convolution layer of the elastic bottleneck block; and configuring a loop parameter based on the intermediate layer mode, wherein the loop parameter configures the number of loops.

Clause 4: The method of any one of Clauses 1-3, further comprising: performing a nonlinear operation on the output of the convolution layer to generate intermediate activation data; and providing the intermediate activation data as an input to a second convolution layer in the elastic bottleneck block.

Clause 5: The method of any one of Clauses 1-4, wherein the number of loops does not change an input size or an output size of the elastic bottleneck block.

Clause 6: The method of any one of Clauses 1-5, further comprising: loading bottleneck block configuration data; and configuring a plurality of convolution layers of the elastic bottleneck block based on the bottleneck block configuration data, wherein: the plurality of convolution layers includes the convolution layer, the bottleneck block configuration data configures a loop parameter for each respective layer of the plurality of convolution layers, and the bottleneck block configuration data configures an input size and an output size for each convolution layer of the plurality of convolution layers.

Clause 7: The method of any one of Clauses 1-6, further comprising: determining the output of the convolution layer based on the summation of loop-specific convolution results associated with each loop of the number of loops and a skip connection from an input of the convolution layer.

Clause 8: The method of any one of Clauses 1-7, wherein the convolution layer is one of a plurality of convolution layers in the elastic bottleneck block.

Clause 9: The method of Clause 8, wherein the convolution layer comprises a pointwise convolution layer.

Clause 10: The method of Clause 8, wherein the convolution layer comprises a depthwise convolution layer.

Clause 11: The method of any one of Clauses 1-10, wherein the number of loops is based on a number of input data sources available for the convolution layer.

Clause 12: The method of any one of Clauses 1-11, further comprising: selecting a subset of input data channels from a set of input data channels, wherein the number of loops is based on a number of the selected subset of input data channels.

Clause 13: A method, comprising: training a first set of weights for an elastic bottleneck block to operate in a basic mode, wherein: in the basic mode, each convolution layer of the elastic bottleneck block is configured to loop once; and training a second set of weights for the elastic bottleneck block to operate in an extended mode, wherein: in the extended mode, one or more convolution layers of the elastic bottleneck block are configured to loop more than once.

Clause 14: The method of Clause 13, further comprising storing the first set of weights and the second set of weights in a memory accessible to the elastic bottleneck block.

Clause 15: The method of Clause 14, further comprising ranking the second set of weights based on an expressivity metric.

Clause 16: The method of Clause 15, wherein the expressivity metric comprises an absolute value of a weight.

Clause 17: The method of Clause 15, further comprising storing weight rankings associated with the second set of weights in the memory.

Clause 18: A processing system, comprising: a memory comprising computer-executable instructions; one or more processors configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium comprising computer-executable instructions that, when executed by one or more processors of a processing system, cause the processing system to perform a method in accordance with any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
determining a number of loops for a convolution layer of an elastic bottleneck block;
for each loop of the number of loops:
loading a loop-specific set of convolution weights;
performing a convolution operation using the loop-specific set of convolution weights; and
storing loop-specific convolution results in a local memory; and
determining an output of the convolution layer based on a summation of loop-specific convolution results associated with each loop of the number of loops.

2. The method of claim 1, further comprising, for each loop of the number of loops, accumulating the loop-specific convolution results to a current convolution results value stored in the local memory.

3. The method of claim 1, further comprising:
determining an intermediate layer mode for the convolution layer of the elastic bottleneck block; and
configuring a loop parameter based on the intermediate layer mode,
wherein the loop parameter configures the number of loops.

4. The method of claim 1, further comprising:
performing a nonlinear operation on the output of the convolution layer to generate intermediate activation data; and
providing the intermediate activation data as an input to a second convolution layer in the elastic bottleneck block.

5. The method of claim 1, wherein the number of loops does not change an input size or an output size of the elastic bottleneck block.

6. The method of claim 1, further comprising:
loading bottleneck block configuration data; and
configuring a plurality of convolution layers of the elastic bottleneck block based on the bottleneck block configuration data,
wherein:
the plurality of convolution layers includes the convolution layer,
the bottleneck block configuration data configures a loop parameter for each respective layer of the plurality of convolution layers, and
the bottleneck block configuration data configures an input size and an output size for each convolution layer of the plurality of convolution layers.

7. The method of claim 1, further comprising: determining the output of the convolution layer based on the summation of loop-specific convolution results associated with each loop of the number of loops and a skip connection from an input of the convolution layer.

8. The method of claim 1, wherein the convolution layer is one of a plurality of convolution layers in the elastic bottleneck block.

9. The method of claim 8, wherein the convolution layer comprises a pointwise convolution layer.

10. The method of claim 8, wherein the convolution layer comprises a depthwise convolution layer.

11. The method of claim 1, wherein the number of loops is based on a number of input data sources available for the convolution layer.

12. The method of claim 1, further comprising:
selecting a subset of input data channels from a set of input data channels,
wherein the number of loops is based on a number of the selected subset of input data channels.

13. A processing system, comprising:
a memory comprising computer-executable instructions;
one or more processors configured to execute the computer-executable instructions and cause the processing system to:
determine a number of loops for a convolution layer of an elastic bottleneck block;
for each loop of the number of loops:
load a loop-specific set of convolution weights;
perform a convolution operation using the loop-specific set of convolution weights; and
store loop-specific convolution results in a local memory; and
determine an output of the convolution layer based on a summation of loop-specific convolution results associated with each loop of the number of loops.

14. The processing system of claim 13, wherein the one or more processors are further configured to cause the processing system to, for each loop of the number of loops, accumulate the loop-specific convolution results to a current convolution results value stored in the local memory.

15. The processing system of claim 13, wherein the one or more processors are further configured to cause the processing system to:
determine an intermediate layer mode for the convolution layer of the elastic bottleneck block; and
configure a loop parameter based on the intermediate layer mode,
wherein the loop parameter configures the number of loops.

16. The processing system of claim 13, wherein the one or more processors are further configured to cause the processing system to:
perform a nonlinear operation on the output of the convolution layer to generate intermediate activation data; and
provide the intermediate activation data as an input to a second convolution layer in the elastic bottleneck block.

17. The processing system of claim 13, wherein the number of loops does not change an input size or an output size of the elastic bottleneck block.

18. The processing system of claim 13, wherein the one or more processors are further configured to cause the processing system to:
load bottleneck block configuration data; and
configure a plurality of convolution layers of the elastic bottleneck block based on the bottleneck block configuration data,
wherein:
the plurality of convolution layers includes the convolution layer,
the bottleneck block configuration data configures a loop parameter for each respective layer of the plurality of convolution layers, and
the bottleneck block configuration data configures an input size and an output size for each convolution layer of the plurality of convolution layers.

19. The processing system of claim 13, wherein the one or more processors are further configured to cause the processing system to determine the output of the convolution layer based on the summation of loop-specific convolution results associated with each loop of the number of loops and a skip connection from an input of the convolution layer.

20. The processing system of claim 13, wherein the convolution layer is one of a plurality of convolution layers in the elastic bottleneck block.

21. The processing system of claim 20, wherein the convolution layer comprises a pointwise convolution layer.

22. The processing system of claim 20, wherein the convolution layer comprises a depthwise convolution layer.

23. The processing system of claim 13, wherein the number of loops is based on a number of input data sources available for the convolution layer.

24. The processing system of claim 13, further comprising
selecting a subset of input data channels from a set of input data channels,
wherein the number of loops is based on a number of the selected subset of input data channels.

25. A method, comprising:
training a first set of weights for an elastic bottleneck block to operate in a basic mode, wherein: in the basic mode, each convolution layer of the elastic bottleneck block is configured to loop once; and
training a second set of weights for the elastic bottleneck block to operate in an extended mode, wherein: in the extended mode, one or more convolution layers of the elastic bottleneck block are configured to loop more than once.

26. The method of claim 25, further comprising storing the first set of weights and the second set of weights in a memory accessible to the elastic bottleneck block.

27. The method of claim 26, further comprising ranking the second set of weights based on an expressivity metric.

28. The method of claim 27, wherein the expressivity metric comprises an absolute value of a weight.

29. The method of claim 27, further comprising storing weight rankings associated with the second set of weights in the memory.

30. A processing system, comprising:
a memory comprising computer-executable instructions;
one or more processors configured to execute the computer-executable instructions and cause the processing system to:
train a first set of weights for an elastic bottleneck block to operate in a basic mode, wherein: in the basic mode, each convolution layer of the elastic bottleneck block is configured to loop once; and
train a second set of weights for the elastic bottleneck block to operate in an extended mode, wherein: in the extended mode, one or more convolution layers of the elastic bottleneck block are configured to loop more than once.
